(19) United States
(12) Patent Application Publication
(10) Pub. No.: US 2006/0266427 A1
(43) Pub. Date: Nov. 30, 2006

(54) Mixing apparatus

(75) Inventor: Armando G. Otero, Guaynabo, PR (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Wyeth Pharmaceuticals.

(21) Appl. No.: 11/436,603

(22) Filed: May 19, 2006

Related U.S. Application Data
(60) Provisional application No. 60/684,558, filed on May 26, 2005.

(51) Int. Cl. B01F 11/00; B01F 15/00; B01F 5/04

(52) U.S. Cl. 137/896; 366/241; 366/347

(57) ABSTRACT

Consistent with an aspect of the present invention, a mixing apparatus is provided which can combine or mix relatively large amounts of solid and liquid ingredients with minimal exposure to undesired impurities. The mixing apparatus includes a hermetically sealed chamber, such as a glove box, for receiving the solid ingredient. The solid ingredient may then be passed from the glove box, through a funnel located therebeneath, to a disperser. The disperser is also closed to the atmosphere, and is configured to mix the liquid and solid ingredients. Since the ingredients are not exposed to air prior to and during the mixing process, little or no contamination occurs. The mixing apparatus consistent with the present invention is particularly suited for manufacturing tigecycline.

### RELATED APPLICATION

This application claims priority benefit based on U.S. provisional application No. 60/684,558, filed on May 26, 2005, the technical disclosure of which is hereby incorporated by reference.

### TECHNICAL FIELD

This invention relates generally to an apparatus and a method to combine or mix relatively large amounts of solid and liquid ingredients, with minimal exposure to undesired impurities.

### BACKGROUND

Pharmaceuticals are often manufactured by mixing a solid or dry ingredient with a liquid ingredient to produce a liquid formulation, which may then be used in subsequent manufacturing steps. The solid and liquid ingredients are typically produced by different equipment, and are thus frequently transported to a location where the mixing is to occur. Although the purity of the ingredients can be maintained during transit, the mixing process can introduce contaminants that can diminish the potency of the final pharmaceutical product.

Tigecycline, a known antibiotic, is one such pharmaceutical which is administered as a liquid formulation. The liquid formulation is manufactured through an intermediate step of mixing solid tigecycline with an appropriate liquid. If the solid tigecycline is exposed to oxygen prior to or during this mixing process, however, the tigecycline liquid formulation can be degraded and rendered unusable.

The present invention provides an apparatus for creating and maintaining particular atmospheric conditions within a mixing apparatus and is directed to overcoming one or more of the problems as set forth above.

### SUMMARY OF THE INVENTION

In accordance with one aspect of the invention, a mixing apparatus is provided which comprises a housing, a channeling unit, and a chamber. The a housing has an aperture, and the channeling unit has first and second openings. The first opening is greater than the second opening and is adjacent to the aperture of the housing. The channeling unit is configured to receive a first material through the aperture and the first opening. In addition, the channeling unit passes the first material through the second opening. A finish associated with a surface of the channeling unit is 10 micro inches or less. The chamber, provided adjacent to the second opening of the channeling unit, has a first port coupled to the second opening of the channeling unit, a second port, and a third port. The chamber is configured to receive the first material through the first port and a second material through the second port. The first and second materials are combined into a mixture in the chamber and output from the chamber through the third port.

According to another aspect of the present invention, a mixing apparatus is provided which comprises a housing, a channeling unit, and a chamber. The housing has an aperture, and the channeling unit has first and second openings. The first opening is greater than the second opening, and is adjacent to the aperture of the housing. The channeling unit is configured to receive a first material through the aperture and the first opening, and to pass the first material through the second opening. The channeling unit, extends along an axis, and has a surface. An angle defined by the axis and a portion of the surface is 30° or less. The chamber is provided adjacent to the second opening of the channeling unit, and has a first port coupled to the second opening of the channeling unit, a second port, and a third port. The chamber is configured to receive the first material through the first port and a second material through the second port. The first and second materials are combined into a mixture in the chamber and output from the chamber through the third port.

According to another aspect of the present invention, a mixing apparatus is provided for mixing first and second materials, and a method is provided for operating the mixing apparatus. The method comprises introducing the first material through an aperture of a housing and passing the first material through a channeling unit by moving the first material through a first opening and then through a second opening. The first opening is greater than the second opening. The channeling unit extends along an axis and has a surface. An angle defined by the axis and a portion of the surface is 30° or less, and a finish associated with the surface of the channeling unit is 10 micro inches or less. The method further comprises feeding the first material into a first port of a chamber, which is provided adjacent to the second opening of the channeling unit. The first port is coupled to the second opening of the channeling unit, and a second material is fed into a second port of the chamber. In addition, the first and second materials are mixed within the chamber, and removed through a third port of the chamber.

According to another aspect of the present invention, an oxygen exclusion apparatus is provided which includes a glove box and a frame. The glove box is attached to a frame, and a funnel is attached to the glove box. An inner surface of the funnel has a surface finish of about 10 micro inches or less. The funnel extends along an axis such that an angle defined by the axis and a portion of the inner surface at the funnel is 30° or less. In addition, a disperser is attached to the funnel.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several exemplary embodiments of the invention and together with the description, serve to explain the principles of the invention.

### BRIEF DESCRIPTION OF THE DRAWINGS

FIG. 1 is a view of a mixing apparatus in accordance with an exemplary embodiment of the present invention

FIG. 2 is an enlarged view of the housing and channeling unit assembly of the mixing apparatus of FIG. 1;

FIG. 3 is an enlarged view of the channeling unit and disperser assembly of the mixing apparatus of FIG. 1;

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

Consistent with an aspect of the present invention, a mixing apparatus is provided which can combine or mix relatively large amounts of solid and liquid ingredients with minimal exposure to undesired impurities. The mixing apparatus includes a hermetically sealed chamber, such as a glove box, for receiving the solid ingredient. The solid ingredient may then be passed from the glove box, through a funnel located therebeneath, to a disperser. The disperser is also closed to the atmosphere, and is configured to mix the liquid and solid ingredients. Since the ingredients are not exposed to air prior to and during the mixing process, little or no contamination occurs. The mixing apparatus consistent with the present invention is particularly suited for manufacturing tigecycline.

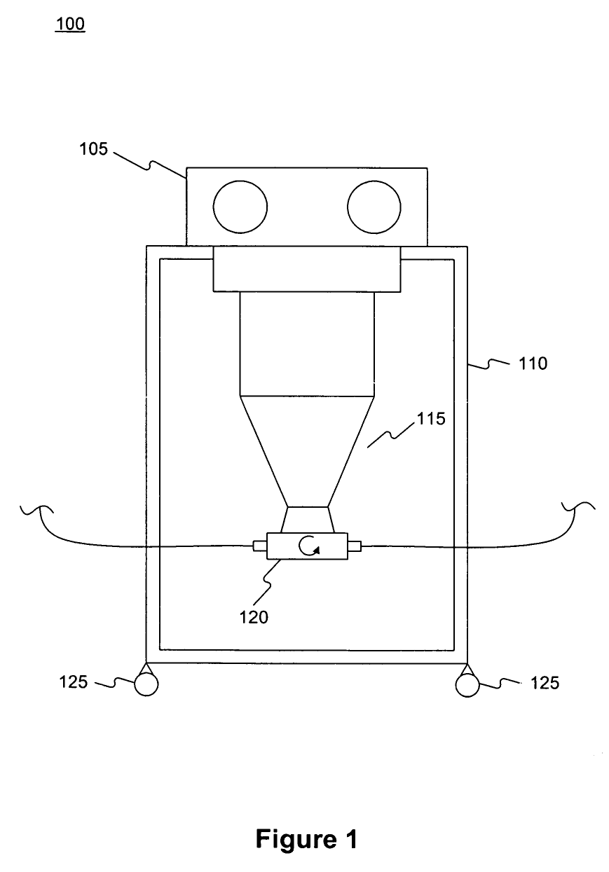

FIG. 1 illustrates a mixing apparatus 100 according to an embodiment of the present invention. Mixing apparatus 100 may include a housing 105, a frame 110, a channeling unit 115, and a disperser 120. The housing 105 is attached to a top portion of frame 110, and a top portion of channeling unit 115 is attached to the underside of the housing 105. A bottom portion of channeling unit 115 is attached to the disperser 120. Housing 105 optionally includes wheels 125 attached to the bottom of the frame 110, thereby providing additional mobility for mixing apparatus 100.

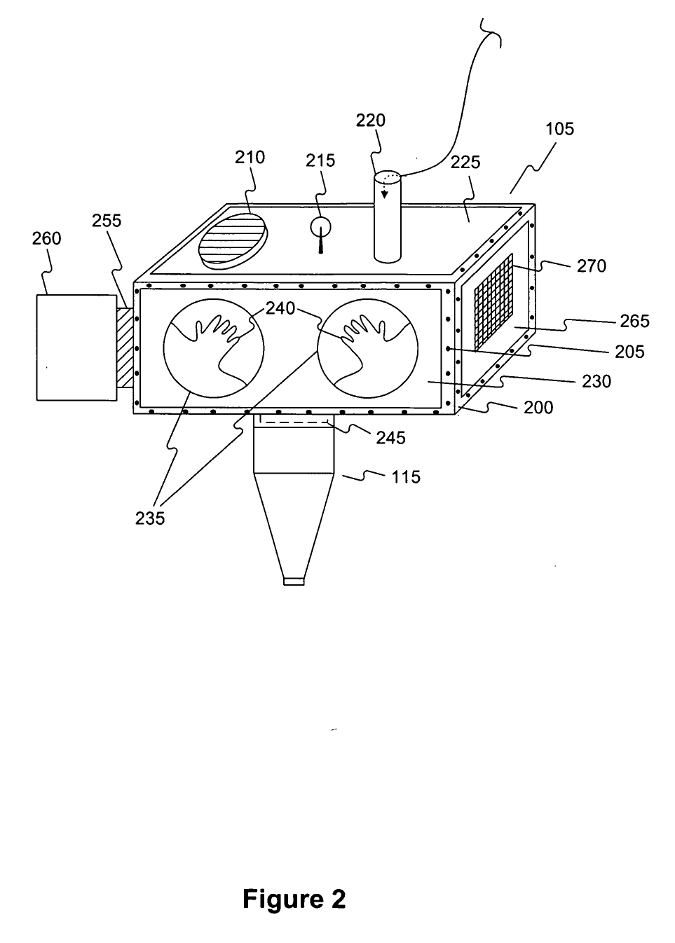

FIG. 2 illustrates housing 105 and channeling unit 115 in greater detail. Housing 105 is preferably a glovebox including panels attached to various portions of housing frame 200 with rivets 205, for example. Other fasteners may be employed in the place of rivets 205 such as, for example, nails, screws, or bolts. The panels may include plexi-glass, or other comparable materials of sufficient durability and strength such as sheet metal, hard plastics, or glass.

As further shown in FIG. 2, an exhaust vent 210, a pressure gage 215, and a gas-inlet port 220 are provided in or on top panel 225 of housing 105. Housing 105 also includes front panel 230 having glove ports 235 to which gloves 240 are attached, and a bottom panel (not shown) having a channeling-unit port 245, to which the channeling unit 115 is attached. In addition, housing 105 includes left panel (not shown) having an ingredient port 255, to which ingredient box 260 may be attached, and right panel 265 having a cleaning access port 270. The housing 105 further includes a back panel (not shown).

Ingredient box 260 is itself sealable, but can be opened when attached to housing 105. Accordingly, solid ingredients can be transported within ingredient box 260, and then removed therefrom and placed within a controlled, contaminant free, environment within housing 105 without exposure to air. Further, the ingredients may be transported in separate containers that can be placed into housing 105.

In particular, once the ingredient box 260 is connected to the ingredient port 255, a user can manipulate gloves 240 to remove the ingredient from the ingredient box 260 and place the ingredient within the closed atmosphere of housing 105. The atmosphere of housing 105 can be sustained or manipulated by introducing a selected gas, or gases, therein via the gas-inlet port 220. Pressure gage 215, noted above, may also be provided to monitor the pressure within housing 105, and exhaust vent 210 can be included to release gas, as necessary, from housing 105.

Once the solid ingredient has been placed within housing 105, a user can further manipulate gloves 240 to direct the ingredient through the channeling-unit port 245 and into the channeling unit 115. Also, once the ingredient is fully processed through mixing apparatus 100, a user can then open the cleaning access panel 270 in order to clean and repair the interior of the housing 105.

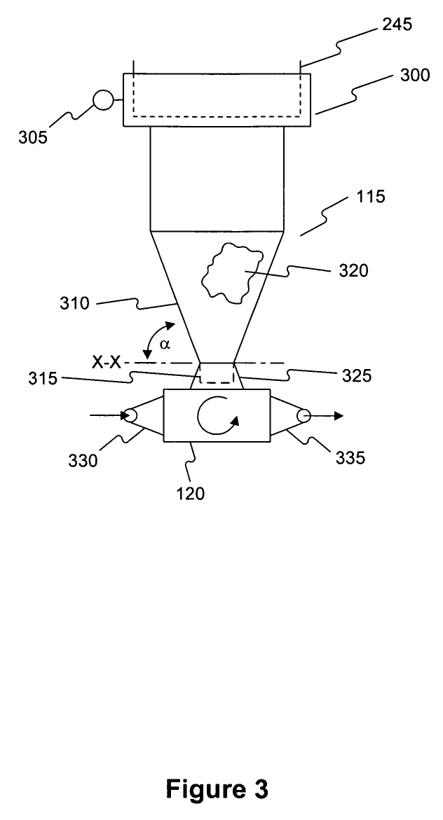

FIG. 3 illustrates channeling unit 115 and disperser 120 in greater detail. Channeling unit 115 including a clamp portion 300 at the top of the channeling unit 115 that engages with the channeling unit-port 245 (See also FIG. 2), and is fastened to the channeling-unit port 245 via a set screw 305, for example. Other fasteners may be employed in place of set screw 305 such as, a bolt, a clamp, a pin, or a shim. Below clamp portion 300 channeling unit 115 includes a funnel 310 and a funnel-outlet port 315. Further, channeling unit 115 includes an interior surface 320. Attached to the funnel-outlet port 315 is ingredient-inlet port 325 of the disperser 120. The ingredient-inlet port 325 may include, for example, a valve, a regulator, or a tap. The disperser 120 also comprises a disperser-inlet port 330 and a disperser-outlet port 335.

After the ingredient is introduced into the tigecycline mixing apparatus 100, the channeling unit 115 delivers the ingredient from the housing 105 to the disperser 120. Funnel 310 of channeling unit 115, is configured to prevent the ingredient from becoming clogged within the channeling unit 115. For example, funnel 310 has an interior surface 320 with a surface finish of 10 micro inches or less. Further, at least a portion of the inner surface 320 of the channeling unit 115 forms an angle of 30° or less with axis X-X extending along the length of the channeling unit 115. The ingredient next enters the funnel-outlet port 315 after passing through funnel 310.

After flowing through the funnel-outlet port 315, the ingredient is introduced into the disperser 120 via the ingredient-inlet port 220. In addition, a liquid ingredient may be introduced into dispenser 120 through disperser-inlet port 330. The liquid and solid ingredients are then mixed in an appropriate manner within disperser 120. The mixed ingredients then exit the disperser 120 via disperser-outlet port 335.

Mixing apparatus 100, is particularly suited for making a relatively pure liquid formulation including tigecycline. In that case, a solid form of tigecycline is delivered in a closed container to the mixing apparatus. The tigecycline may be placed in ingredient box 260, which is connected to housing 105. At this point the container holding the tigecycline is opened by gloves 240 to expose the solid tigecycline within the controlled environment of housing 105. While in the housing 105, the tigecycline is subjected to sparging by gaseous nitrogen fed into housing 105 through gas-inlet port 220 at about 10 to 15 psi (0.6805 to 1.02075 atm). This sparging process helps to eliminate the free oxygen content within the solid tigecycline.

After the solid tigecycline has been sparged within housing 105, the gloves 240 may be used to feed the solid tigecycline into funnel 310 of channeling unit 115. To prevent solid tigecycline from sticking to the walls of funnel 310, the funnel ideally has a surface finish of about 10 micro inches or less. Further, to prevent compaction of the tigecycline as it enters disperser 120, the walls of the funnel form about a 30° angle α, or less, with axis X-X along the length of funnel 310. Once the solid tigecycline passes through funnel 310, the solid tigecycline enters disperser 120 where it is mixed with a liquid, such as deionized water, that has also been sparged with gaseous nitrogen, to form the liquid formulation. The liquid formulation is then output through disperser-outlet port 335.

In sum, by providing a hermetically sealed chamber, such as a glove box for receiving an ingredient, the ingredient may be passed through a funnel to a disperser while achieving a low level of impurities. Further, the mixing apparatus allows the tigecycline to maintain an acceptable level of impurities while being mixed with a liquid via a disperser. Lastly, the mixing apparatus enables the processing of tigecycline into a liquid formulation.

Following the formation of the liquid formulation, the liquid formulation is removed from disperser 120 and placed in a formulation tank for additional mixing. Upon completion of the mixing process, the solution is transferred to a holding tank where the solution undergoes a filtration process to further remove any impurities. After filtration, the solution is processed through a filling line to deposit measured amounts of solution in vials. Once the solution is dispensed into vials, a further lyophilization process may be applied to the solution to increase shelf life of the tigecycline.

It will be apparent to those skilled in the art that various modifications and variations can be made in the methods of the present invention and in the construction of this mixing apparatus without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A mixing apparatus, comprising:
a housing having an aperture;
a channeling unit having first and second openings, said first opening being greater than said second opening, said first opening being adjacent said aperture of said housing, said channeling unit being configured to receive a first material through said aperture and said first opening, and to pass said first material through said second opening, a finish associated with a surface of said channeling unit being 10 micro inches or less; and
a chamber provided adjacent said second opening of said channeling unit, said chamber having a first port coupled to said second opening of said channeling unit, a second port, and a third port, said chamber being configured to receive said first material through said first port and a second material through said second port, said first and second materials being combined into a mixture in said chamber and being output from said chamber through said third port.

2. The mixing apparatus of claim 1, wherein said channeling unit includes a funnel.

3. The mixing apparatus of claim 1, wherein said first material includes tigecycline.

4. The mixing apparatus of claim 1, wherein a concentration of oxygen in said mixture being 0.8%/vol. or less.

5. The mixing apparatus of claim 1, wherein said second material includes water.

6. The mixing apparatus of claim 1, wherein said channeling unit extends along an axis, an angle defined by said axis and a portion of said surface being 30° or less.

7. The mixing apparatus of claim 1, wherein said housing includes a glove box.

8. The mixing apparatus of claim 1, wherein movement of said first material through said channeling unit is assisted by gravity.

9. The mixing apparatus of claim 1, wherein said surface of said channeling unit is an inner surface.

10. A mixing apparatus, comprising:
a housing having an aperture;
a channeling unit having first and second openings, said first opening being greater than said second opening, said first opening being adjacent said aperture of said housing, said channeling unit being configured to receive a first material through said aperture and said first opening, and to pass said first material through said second opening, said channeling unit extending along an axis and having a surface, an angle defined by said axis and a portion of said surface being 30° or less; and
a chamber provided adjacent said second opening of said channeling unit, said chamber having a first port coupled to said second opening of said channeling unit, a second port, and a third port, said chamber being configured to receive said first material through said first port and a second material through said second port, said first and second materials being combined into a mixture in said chamber and being output from said chamber through said third port.

11. The mixing apparatus of claim 10, wherein said channeling unit includes a funnel.

12. The mixing apparatus of claim 10, wherein said first material includes tigecycline.

13. The mixing apparatus of claim 10, wherein a concentration of oxygen in said mixture being 0.8%/vol. or less.

14. The mixing apparatus of claim 10, wherein said second material includes water.

15. The mixing apparatus of claim 10, wherein said housing includes a glove box.

16. The mixing apparatus of claim 10, wherein movement of said first material through said channeling unit is assisted by gravity.

17. The mixing apparatus of claim 10, wherein said surface of said channeling unit is an inner surface.

18. The mixing apparatus of claim 10, wherein said surface of said channeling unit has a finish being 10 micro inches or less.

19. In a mixing apparatus for mixing a first and a second material, a method of operating said mixing apparatus comprising:
introducing said first material through an aperture of a housing;
passing said first material through a channeling unit by moving said first material through a first opening and then through a second opening, the first opening being greater than the second opening, the channeling unit extending along an axis and having a surface, an angle defined by said axis and a portion of the surface being 30° or less, and a finish associated with said surface of said channeling unit being 10 micro inches or less;
feeding said first material into a first port of a chamber, said chamber being provided adjacent to said second opening of said channeling unit, said first port being coupled to said second opening of said channeling unit;
feeding a second material into a second port of said chamber;
mixing said first and second materials within said chamber; and
removing the mixed first and second materials through a third port of said chamber.

20. The method of claim 19, wherein said first material is tigecycline.

21. The method of claim 19, wherein said second material is water.

22. The method of claim 19, wherein said first material is sparged by a gas within said housing.

23. The method of claim 20, wherein said gas is nitrogen.

24. The method of claim 19, wherein passing said first material through said channeling unit is assisted by gravity.

25. An oxygen exclusion apparatus comprising:
a frame;
a glove box attached to the frame,
a funnel attached to said glove box,
wherein an inner surface of said funnel has a surface finish of about 10 micro inches or less, and
wherein said funnel extends along an axis, an angle defined by said axis and a portion of said inner surface being 30° or less; and
a disperser attached to said funnel.
